(19) United States
(12) Patent Application Publication
(10) Pub. No.: US 2008/0282097 A1
(43) Pub. Date: Nov. 13, 2008

(54) METHOD FOR INDICATING A POWER SWITCH OF A COMPUTER AND DEVICE THEREOF

(76) Inventor: WEN-CHI CHEN, Jumg-Ho (TW)

Correspondence Address: G. LINK CO., LTD, 3550 BELL ROAD, MINOOKA, IL, 60447, US

(21) Appl. No.: 11/746,514

(22) Filed: May 9, 2007

(51) Int. Cl. G06F 1/32; F21V 7/04

(52) U.S. Cl. 713/320; 362/612

(57) ABSTRACT

A device for indicating the power switch of a computer is disclosed in the invention, which is applied in portable computers and indicates the position of a power switch of a portable computer when the computer is in shutdown status. The portable computer comprises at least a monitor and a main system, wherein an indicating device is also disposed in the portable computer; the indicating device includes a detecting unit, an illuminating element, and a controller. The detecting unit detects whether the monitor and the main system have been unclosed and separated from each other; if the detection result is “true”, a trigger signal is exported. The illuminating element is disposed in the proximity of the power switch on the portable computer. The controller accepts the trigger signal and adjusts the illumination of the illuminating element.

### FIELD OF THE INVENTION

The invention relates to a method for indicating a power switch of a computer and device thereof, and in particular to a method for indicating a power switch of a computer and device thereof being applicable to portable computers.

### BACKGROUND OF THE INVENTION

Conventional portable computers are popular among consumers for their portability and functionality. However, though portable computers have become widely popularized, there are certain aspects of portable computers that still require further amendment. Using the notebook computer as an example; there are many different brands of notebook computers available currently, and each has a unique design for the power switch thereof, but this means users must spend time familiarizing themselves with the location of the power switch when they start to use a new brand of notebook computer each time, and this poses a great inconvenience to users. If users need to use such notebook computers in dark surroundings or any places with insufficient lighting, they often have to fumble for the power switch in order to turn on the computer, which renders the computer user-unfriendly.

In Taiwan patent application No. 86205060 titled “A Portable Computer Having A Power Switch Showing Status Of Standby”, it discloses a portable computer with its lid pivotally connected to a base; when the lid is turned away or closed with the base, a power switch disposed on the base shows either the power is switched on or on standby. The power switch comprises at least a button, an illuminator, and an illuminating switch. The button may be made of fluorescent materials, or has a surface coated with fluorescent paint, or painted with fluorescent symbols, so that users may easily locate the power switch on the base by the fluorescent button in dark surroundings or any places with insufficient lighting.

In the aforesaid disclosure, the illuminating switch in the power switch of the portable computer cannot emit light when the computer is in shutdown status; the power switch can only be located by relying on the fluorescent button. However, the fluorescence of the button may interfere with the overall aesthetic unity of the portable computer; on the other hand, the light generated from the fluorescent button is limited, and thus does not fulfill the purpose of guiding users to it.

In light of the aforesaid disadvantages, a method for indicating a power switch of a computer and device thereof have been disclosed, so as to meet the demands of users, and make the use of computers more convenient and ergonomic.

### SUMMARY OF THE INVENTION

A method for indicating a power switch of a computer and device thereof have been disclosed in this invention, which indicate the position of the power switch on a portable computer, and help users quickly locate the power switch and turn on the computer when the computer is in shutdown status.

To achieve the aforesaid purposes, a device for indicating a power switch of a computer has been proposed in the invention, which indicates a power switch of a portable computer when the computer is in shutdown status. The portable computer comprises at least a monitor and a main system, wherein an indicating device is also disposed in the portable computer; the indicating device includes a detecting unit, an illuminating element, and a controller. The detecting unit detects whether the monitor and the main system have been unclosed and separated from each other; if the detection result is “true”, a trigger signal is exported. The illuminating element is disposed in the proximity of the power switch on the portable computer. The controller accepts the trigger signal and adjusts the illumination of the illuminating element.

Moreover, a method for indicating a power switch of a computer has also been disclosed in the invention, which relies on the indicating device to indicate a power switch of a portable computer when the computer is in shutdown status. The portable computer comprises at least a monitor and a main system, wherein the indicating device is also disposed in the portable computer; and the indicating device includes a detecting unit, an illuminating element, and a controller; the illuminating element is disposed in the proximity of the power switch on the portable computer. The method comprising: a first step in which the detecting unit detects whether the monitor and the main system have been unclosed and separated from each other; if the detection result is “true”, subsequently exporting a trigger signal; a second step in which the controller accepts the trigger signal and adjusts the illumination of the illuminating element.

### BRIEF DESCRIPTION OF THE DRAWINGS

The purpose and the effects of the present invention may be best understood by those skilled in the art by referring to the following detailed description of the preferred embodiments and the accompanying drawings, wherein:

FIGS. 1A and 1B show the preferred embodiments of portable computers according to the invention;

FIG. 2 shows the block diagram of an indicating device on a computer according to the invention;

FIG. 3 is a schematic view that shows the circuit of the indicating device from FIG. 2 according to the invention; and

FIG. 4 is a flow chart that shows the method for indicating a power switch of a computer according to the invention.

### DETAILED DESCRIPTION OF THE INVENTION

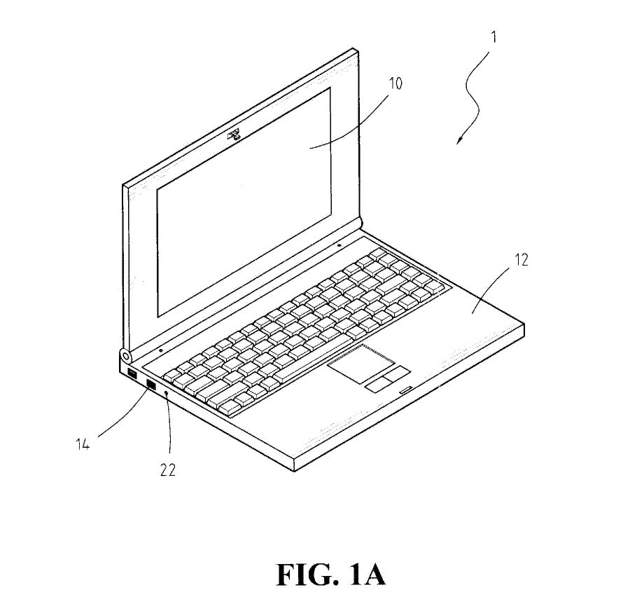

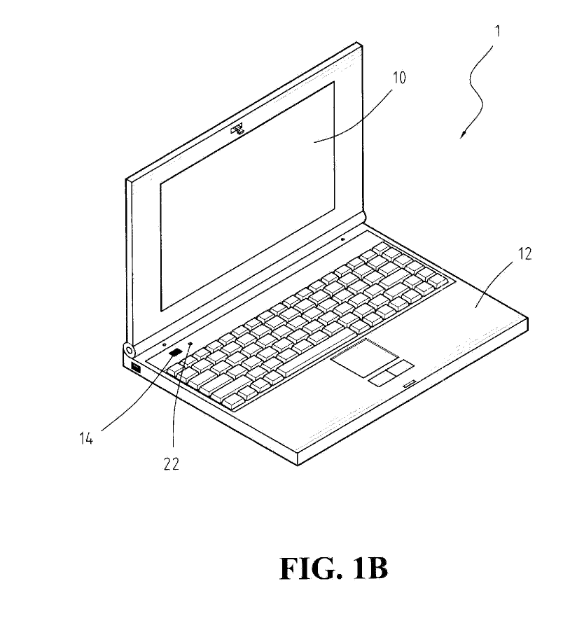

FIGS. 1A and 1B show the preferred embodiments of portable computers according to the invention. As indicated in both FIG. 1A and FIG. 1B, a portable computer 1 with the disclosed device and method applied thereon may be a notebook computer of prior arts. The portable computer 1 has a monitor 10 and a main system 12, and a power switch 14 of the portable computer 1 is disposed on a lateral surface of the main system 12, as observed in FIG. 1A. Alternatively, the power switch 14 of the portable computer 1 may be disposed above the position of the keyboard on the main system 12, as shown in FIG. 1B.

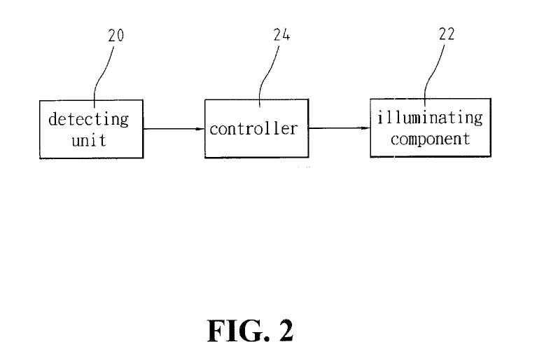

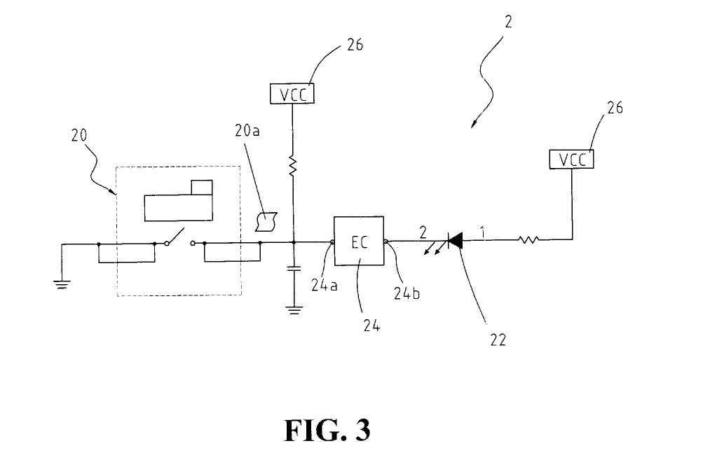

FIG. 2 shows the block diagram of an indicating device on a computer according to the invention, whereas FIG. 3 is a schematic view that shows the circuit of the indicating device from FIG. 2 according to the invention. When the portable computer 1 is in shutdown status, the indicating device 2 of the invention indicates the position of the power switch 14 on the portable computer 1 as shown in FIGS. 1A and 1B. The indicating device 2 includes a detecting unit 20, an illuminating element 22, and a controller 24, and the functions thereof are described as follows. The detecting unit 20 detects whether the monitor 10 and the main system 12 have been unclosed and separated from each other; if the detection result is “true”, a trigger signal 20a is exported as a result. For example, a notebook computer is closed by shutting the monitor 10 and the main system 12 together, but if a user pulls the monitor 10 away from the main system 12 (as shown in FIGS. 1A and 1B), the detecting unit 20 would detect the monitor 10 and the main system 12 are no longer closed, and export a trigger signal 20a.

The illuminating element 22 is disposed in the proximity of the power switch 14 on the portable computer 1. Referring to FIGS. 1A and 1B, the illuminating element 22 is disposed immediately adjacent to the power switch 14. However, it should be noted that in this invention, the positions of the power switch 14 and the illuminating element 22 are not limited to that shown in FIGS. 1A and 1B, and may be freely altered as required. Moreover, the illuminating element 22 may be further embedded into a power switch 14 made of transparent materials (for instance, transparent plastic), so that the light emitted from the illuminating element 22 may pass through the power switch 14 for the purpose of indicating. Furthermore, the illuminating element 22 may be a light-emitting diode (LED).

The controller 24 accepts the trigger signal 20a and controls the illumination of the illuminating element 22. How the controller 24 controls the illumination of the illuminating element 22 will be described hereafter. A signal-inputting end 24a of the controller 24 is electrically connected to the detecting unit 20, and a signal-outputting end 24b of the controller 24 is electrically connected to an end of the LED 22. The controller 24 may make use of built-in controlling components in the portable computer 1, such as keyboard controlling components.

The detecting unit 20 of the invention may be selected from the group consisting of a G-sensor, an optical sensor, a reed switch sensor, and a mechanical switch sensor.

The indicating device 2 makes use of a power supply 26, which may also be a direct power supply of the portable computer 1, such as a rechargeable lithium battery of the portable computer 1, or the power supply outputted from an AC to DC adapter. When the portable computer 1 is in shutdown status, the standby power from the power supply 26 may provide power for the indicating device 2.

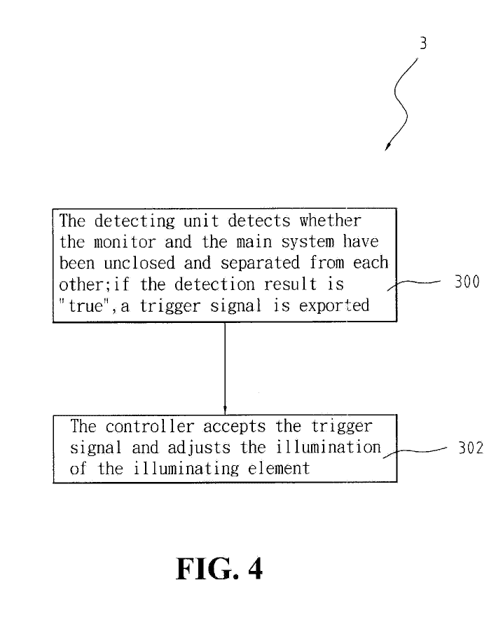

FIG. 4 is a flow chart that shows the method for indicating a power switch of a computer according to the invention. According to the invention, the method 3 for indicating a power switch of a computer is applicable when the portable computer 1 is in shutdown status, and utilizes the indicating device 2 to indicate the position of the power switch 14 on the portable computer 1. The portable computer 1 comprises at least a monitor 10 and a main system 12, and the indicating device 2 is disposed on the portable computer 1, which includes a detecting unit 20, an illuminating element 22, and a controller 24. The illuminating element 22 is disposed in the proximity of the power switch 14 on the portable computer 1.

By applying the method 3 of the invention, the standby power of the power supply 26 may provide power for the indicating device 2 when the portable computer 1 is in shutdown status. The method 3 comprises a step 300 and a step 302. In the step 300, the detecting unit 20 detects whether the monitor 10 and the main system 12 have been unclosed and separated from each other; if the detection result is “true”, the detecting unit exports a trigger signal 20a consequently. In the step 302, the controller 24 accepts the trigger signal 20a, and subsequently controls the illumination of the illuminating element.

The illumination of the aforesaid illuminating element 22 may be devised by the manufacturers of computer systems. For instance, the illuminating element 22 may be controlled in such a way that it shifts from bright to dark, or flashes continuously.

In summary, the advantages and functions of the invention are further described below. In this invention, the device for indicating the power switch of a computer is particularly useful in dark workplaces or any places with insufficient lighting. When a user pulls up the monitor of the portable computer, the user can easily locate the power switch via the illumination of the illuminating element. Moreover, the indicating device is also useful to users who are using unfamiliar portable computers, by which the users can still locate the power switch quickly even if the position of the power switch is unknown to them. Therefore, the indicating device of the invention is not only user-friendly but also ergonomic.

The present invention has been described with preferred embodiments thereof, and it is understood that many changes and modifications to the described embodiment can be carried out without departing from the scope and the spirit of the invention that is intended to be limited only by the appended claims.

What is claimed is:

1. A device for indicating a power switch of a computer, which is applied in a portable computer for indicating the position of a power switch on a portable computer when the computer is in shutdown status; wherein the portable computer comprises at least a monitor and a main system, and an indicating device is also disposed on the portable computer; the indicating device comprising:
a detecting unit for detecting whether the monitor and the main system have been unclosed and separated from each other; if the detection result is “true”, the detecting unit exports a trigger signal consequently;
an illuminating element disposed in the proximity of the power switch on the portable computer; and
a controller for accepting the trigger signal and for controlling the illumination of the illuminating element.

2. The device of claim 1, wherein the detecting unit, the illuminating element, and the controller are electrically connected to a power supply.

3. The device of claim 1, wherein a signal-outputting end of the controller is electrically connected to an end of the illuminating element, and the signal-inputting end of the controller is electrically connected to the detecting unit.

4. The device of claim 1, wherein the illuminating element is a light-emitting diode (LED).

5. The device of claim 1, wherein the detecting unit is selected from the group consisting of a G-sensor, an optical sensor, a reed switch sensor, and a mechanical switch sensor.

6. The device of claim 1, wherein the portable computer is a notebook computer.

7. A method for indicating a power switch of a computer, which is applied in a portable computer for indicating the position of a power switch on a portable computer when the computer is in shutdown status; wherein the portable computer comprises at least a monitor and a main system, and an indicating device is also disposed on the portable computer; the indicating device includes a detecting unit, an illuminating element, and a controller, and the illuminating element is disposed in the proximity of the power switch on the portable computer; the method comprising:
(a) detecting whether the monitor and the main system have been unclosed and separated from each other via the detecting unit; if the detection result is “true”, the detecting unit exports a trigger signal consequently;
(b) accepting the trigger signal and controlling the illumination of the illuminating element via the controller.

8. The method of claim 7, wherein the controller in the step (b) adjusts the illumination of the illuminating element, so that the illuminating element is shifted from bright to dark.

9. The method of claim 7, wherein the controller in the step (b) makes the illuminating element flash continuously.
